(19) United States
(12) Patent Application Publication
(10) Pub. No.: US 2003/0014512 A1
(43) Pub. Date: Jan. 16, 2003

(54) Communication apparatus and structured document management apparatus

(75) Inventor: Yoshifumi Tanimoto, Hirakata-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/192,928

(22) Filed: Jul. 9, 2002

(30) Foreign Application Priority Data
Jul. 12, 2001 (JP) 2001-212712
Jul. 10, 2001 (JP) 2001-208650
Jul. 13, 2001 (JP) 2001-213687

(51) Int. Cl. G06F 15/173

(52) U.S. Cl. 709/223

(57) ABSTRACT

A communication apparatus includes a memory storing management information in a structured document format. The communication apparatus also includes a network communication unit communicating with at least one of a plurality of network apparatuses through networks. A control unit receives and transmits the management information in the structured document format between at least one of the plurality of network apparatuses via the network communication unit.

### BACKGROUND OF THE INVENTION

1. Field of the Invention

The present invention relates to a communication apparatus connected to other apparatus over networks and a structured document management apparatus for managing a plurality of communication apparatuses. More particularly, the present invention relates to a structured document management apparatus for managing a history of reading and updating structured documents and expiration.

2. Description of the Related Art

Recent developments in network management systems have improved the management of information between multiple communication apparatuses. For example, a communication apparatus such as a facsimile machine can be connected to other communication apparatuses as well as various other network apparatuses over one or more networks such as a local area network (LAN). The facsimile machine includes a management function for managing management information received from and transmitted to the other communication and network apparatuses. Management information includes information such as various settings for the facsimile machine, a transfer of a communication history, etc.

The facsimile machine communicates with the other communication and network apparatuses using a specific or dedicated protocol determined by the received or transmitted management information. In the network, the network and communication apparatuses have many different models or types. Each of the different models may utilize a different protocol to communicate. For example, an earlier model and a later model of a communication apparatus can be connected to the network with each model utilizing a different protocol. As the number of network and communication apparatuses connected to the network increases, it becomes difficult to manage the various network and communication apparatuses having different protocols. This is because each network or communication apparatus must include the protocol for each of the other apparatuses connected to the network in order to communicate with these apparatuses. Thus, each time a new apparatus, having a protocol different from any protocol currently used by the network, is added to the network, the other network and communication apparatuses must be updated with this different protocol.

Moreover, the format of the data handled by the network or communication apparatus also changes according to the model or type of the network or communication apparatus. Thus, it is difficult to manage the output of data (i.e., how it is formatted) for a plurality of network and communication apparatuses having different models. Structured documents have been developed to solve this problem.

Standard documents utilize markup languages for data formatting. Markup languages such as Extensible Markup Language (XML), Scalable Vector Graphics (SVG), Extensible Hypertext Markup Language (XHTML) and Voice Extensible Markup Language (VoiceXML) are presently being considered as standards for structured documents. XML is the common language among the languages listed above. XML structures data in a document using embedded tags that give names for fields in the data. Unlike the Hypertext markup language (HTML) that is the specific markup language used for the World Wide Web, XML does not specify formatting information. Instead, XML gives an internal representation that provides names for each field in a data item. XML does not assign any meaning to the tags. Thus, tag names can be created as needed.

The characteristics of XML is that attribute names can be newly defined to structured data. An attribute is a set including a data name and the data itself, and the data is interpreted by names and the process can be done when the name corresponds to the meaning and content of data.

### SUMMARY OF THE INVENTION

It is a first aspect of the present invention to provide a communication apparatus and a structured document management apparatus which can easily manage, receive, transmit and process management information.

It is a second aspect of the present invention to easily manage history information of structured documents in various markup languages such as XML, SVG, etc.

It is a third aspect of the present invention to immediately recognize users that access structured documents.

It is a forth aspect of the present invention to manage who accesses the documents and what types of access the documents has been made.

It is a fifth aspect of the present invention to easily manage an expiration of the structured documents in the various markup languages such as XML, SVG, etc.

It is a sixth aspect of the present invention to immediately recognize that the document read by users has expired.

It is a seventh aspect of the present invention to properly process the expired documents.

A communication apparatus of the present invention includes a memory storing management information in a structured document format. The communication apparatus also includes a network communication unit communicating with at least one of a plurality of network apparatuses through networks. A control unit receives and transmits the management information in the structured document format between network apparatuses via the network communication unit.

Also, the communication apparatus of the present invention includes a memory for storing management information. A network communication unit communicates with at least one of a plurality of network apparatuses through networks. A control unit translates the management information read from the memory into a structured document format before transmitting the management information to at least one of the plurality of network apparatuses and translates the management information in the structured document format received from at least one of the plurality of network apparatus into the management information before storing the management information in the memory.

Further, the communication apparatus of the present invention includes a network communication unit for communicating with at least one of a plurality of network apparatuses through networks. The apparatus also includes a control unit for processing information based on a command accepted by at least one of the plurality of network apparatuses through the network communication unit, and accepts the command described in a structured document format.

In the present invention, the management information and the command in the structured document format are exchanged between the communication apparatus and at least one of a plurality of network apparatuses, so that different protocols of the communication apparatus models and the management information types can be eliminated and the data in a standardized structured document format can be exchanged. Consequently, even if a plurality of various kinds of the communication apparatus is connected, the communication apparatus is replaced with the other apparatus or various kinds of management information are exchanged, the management information can be easily managed by the standardized structured document format and the process can be easily done as the data format is standardized.

Additionally, the management information is considered to be apparatus setting information defining the operation of the communication apparatus, the history information receiving and transmitting data, destination information such as a name, a telephone number and an address etc., source address information in broadcasting and delivery setting information such as a destination and a delivery information in receiving etc. Of course, the other information can be received and transmitted as the management information.

In the present invention, a structured document management apparatus for managing at least one of a plurality of communication apparatuses such as a management server includes a network communication unit for communicating with the communication apparatus through networks. The structured document management apparatus also includes a management unit for receiving and transmitting management information in a structured document format among at least one of the plurality of communication apparatuses through the network communication unit and managing the management information of the network communication unit.

A structured document management apparatus for managing at least one of a plurality of communication apparatuses of the present invention includes a network communication unit for communicating with at least one of a plurality of network apparatuses through networks. The structured document management apparatus also includes a management unit for managing a process in the communication unit and requesting a process to the communication unit, which characterizes in requesting a process to the communication unit with a command in the structured document format.

The management information and the commands can be exchanged by using standardized structured document format between the above communication apparatus in the structured document management apparatus. Moreover, as the data format is standardized, all of the communication apparatus can be managed even if managing different communication apparatus.

In the present invention, the structured document management apparatus for managing the structured documents is equipped with an embedded (markup) means for embedding the structured document history information in the structured document as the attribute information. Preferably, the history information includes information on users accessing to the structured document. More preferably, the history information includes access information to the structured document.

A structured document management method of the present invention for managing the structured document is equipped with an embedded step for embedding the structured document history information in the structured document as the attribute information. Preferably, the history information includes information on users accessing to the structured documents. More preferably, the history information includes the access information to the structured document.

The present invention manages the structured document history information. The history information after generating documents is embedded in the attribute information of the structured document as the history information. The history information includes reading and updating data in documents by users. If the history information is provided in the attribute information of the structured document, the history information can be managed with the structured document itself and there is no need to manage the history information separately by making database etc. for managing documents. Moreover, it is convenient as the history information of the document can be recognized at a glance. When the user information such as a user's name etc. is included in the history information, the history information can be managed such that which user accesses frequently.

The history information includes the user access information. When the access information includes the access type such as reading and updating, the time and a history that which information is updated, the detail of the history can be recognized and the document can be easily managed. Additionally, the update of the document includes adding, changing and eliminating the contents of the document.

The structured document management apparatus of the present invention is equipped with a means for embedding a generation time of the structured document and a lapsed time from the generation time in the structured document as the attribute information of the structured documents and a means for managing the expiration of the structured document based on the above generation time and the lapsed time.

Preferably, the expiration information showing that the lapsed time is over at a predetermined time and the structured document has expired is embedded in the structured document as attribute information. More preferably, the above expiration information includes a message indicating the structured document has expired. More preferably, the follow up information of the expired structured document is embedded as expiration information.

The method for managing a structured document of the present invention is provided with a step for embedding the generation time of the structured document and the lapsed time from the generation time in the structured document as attribute information of the structured document and a step for managing the expiration of the structured document based on the generation time and the lapsed time.

Preferably, the embedding of the expiration information shows that a lapsed time is over at a predetermined time and the structured document has expired in the structured document as attribute information. More preferably, the expiration information includes a message indicating the structured document has expired. Furthermore preferably, embedding follow up information of the expired structured document as expiration information is provided.

The present invention manages the expiration of the structured document. The generation time of generating the document and the lapsed time from the generation time are embedded in the attribute information of the structured document, and the generation time and the lapsed time of the document are managed, and the expiration of the document is managed by the expiration of the document after a predetermined lapsed time. As the information can be managed with the structured document itself by providing information for managing the expiration in the attribute information of the structured document, the update time is clear and the expiration can be easily managed even if the document is updated etc., and all of the attribute information of multiple structured documents can be changed. The document can be easily managed as the lapsed time from the generation time of the document and the time to the expiration can be recognized immediately from the attribute information. Further, the expiration can be managed correctly by acquiring the lapsed time from the generation time when the generation time and the lapsed time are managed even if the times of a plurality of the terminals connected to the document management system are different. Furthermore, the expiration can be managed correctly even if the time of the clock for managing the system is wrong such that the time is one year set forward.

Further, if the expiration (time out) information is embedded in the attribute information, the expiration can be recognized immediately when users try to read the expired document. For example, it is user friendly when the message of the expiration is embedded in the expiration information, the key word showing the expiration is added to the document name or the expiration can be recognized by seeing a file list.

Furthermore, regarding the expired document, the process after the expiration can be embedded in the attribute. For example, when users are prohibited from reading and editing the expired document and the process such that the corresponding data is deleted after passing the predetermined time after the expiration is embedded in the attribute, users can recognize the process to the expired document and the process can be done in the document management apparatus. The process of deleting and storing the expired document data can be inquired of users and it can be transmitted to the database for the storage etc.

### BRIEF DESCRIPTION OF THE DRAWINGS

FIG. 1 is a diagram illustrating an example of a communication system including a preferred embodiment of a communication apparatus and a management server of the present invention.

FIG. 2 is a diagram describing an example of management information written in XML.

FIG. 3 is a block diagram of a management apparatus for the structured document in the preferred embodiment of the present invention.

FIG. 4 is a flow chart describing a management program of a structured document in a preferred embodiment of the present invention.

FIG. 5 is a diagram illustrating an example of a XML document embedding history information for reading and updating the document.

FIG. 6 is a block diagram illustrating another embodiment of the management apparatus for the structured document in the preferred embodiment of the present invention.

FIG. 7 is a flow chart describing another management program of the structured document in the preferred embodiment of the present invention.

FIG. 8 is a diagram illustrating an example of the XML document embedding a generation time and a lapsed time.

FIG. 9 is a diagram illustrating an example of the XML document embedding an expiration message and an expiration process.

### DETAILED DESCRIPTION OF THE INVENTION

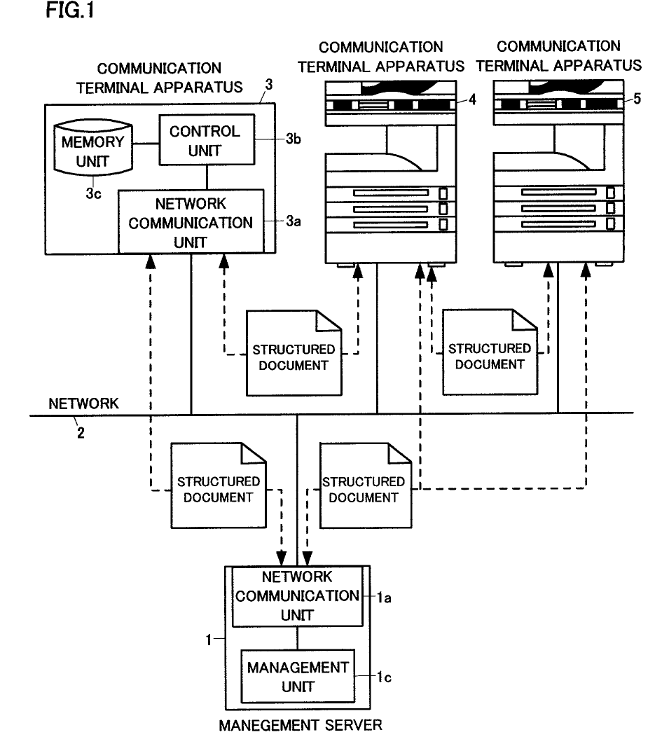

FIG. 1 is a block diagram illustrating an example of a communication system including a plurality of communication apparatuses and a structured document management apparatus (management server) according to one embodiment of the present invention. The communication system includes a management server 1, a network 2 and communication terminal apparatuses 3˜5. The management server 1 includes a network communication unit 1a and a management unit 1c. Communication terminal apparatus 3 includes a network communication unit 3a, a control unit 3b and a memory unit 3c. Although communication terminal apparatus 3 is shown in detail, the other communication terminal apparatuses 4 and 5 include the same features. The management server 1 and the plurality of communication terminal apparatuses 3˜5 are connected so as to communicate over the network 2. Other management servers and communication terminal apparatuses (not shown) can be connected to the network 2 such that the number of communication terminal apparatuses does not limit three. Other types of network apparatuses can also be connected to network 2. Network 2 can be a public line or a leased line, etc. as well as a local area network (LAN). The communication system may be wired or wireless communication system.

The management server 1 manages the communication terminal apparatuses 3˜5. As stated above, the management server 1 includes the network communication unit 1a and the management unit 1c. The network communication unit 1a communicates with the communication terminal apparatuses 3˜5 and other network apparatuses over network 2. The management unit 1c manages all aspects of the communication terminal apparatuses 3˜5. Here in particular, the management unit 1c manages the management information stored in each communication terminal apparatus 3˜5, and transmits the management information to each communication terminal apparatus 3˜5 through the network communication unit 1a, and receives the management information retained by each communication terminal apparatus 3˜5. The management information is created in a structured document format when the management information is received and transmitted between the management server 1 and the communication terminal apparatuses 3˜5. Further, the management unit 1c manages the transmission and reception of information to and from the communication terminal apparatuses 3˜5 and categorizes this management information. The management unit 1c also instructs the communication terminal apparatuses 3˜5 to transmit and receive information. The instruction to transmit and receive information can also be made in the structured document format.

The communication terminal apparatuses 3˜5 according to one embodiment of the present invention, communicate with other communication terminal apparatuses using network 2 or another public line or leased line etc. (not shown). For example, one communication terminal apparatus may have facsimile capabilities and utilize the public line. The communication terminal apparatus may include a scanning device such as a scanner. The scanned information is transmitted by the communication terminal apparatus and received by the management server 1 or by another network apparatus over network 2. In addition, the scanned information may be output as a hard copy by a printing device such as a printer or output by a display device such as a monitor and then transferred to the management server 1 or the other network apparatuses over network 2. Additionally, the transmitted and received information is sent over network 2 in the structured document format.

The communication terminal apparatuses 3˜5 communicate through the management server 1 and the network 2, receive management information from the management server 1, retain the management information and transmit the retaining management information to the management server 1. When management information is received and transmitted among the communication terminal apparatuses 3˜5, the management information is created in the structured document format.

The communication terminal apparatus 3 includes the network communication unit 3a, the control unit 3b and the memory unit 3c. The network communication unit 3a communicates with the management server 1, the communication terminal apparatuses 4 and 5 and with other network apparatuses over network 2. For example, the network communication unit 3a receives information to be transmitted to the other communication terminal apparatus and the management information to the communication terminal apparatus 3 and passes them to the control unit 3b. The network communication unit 3a also receives the information received from the other communication terminal apparatus and the management information transmitted to the management server 1 from the control unit 3b and transfers them.

The control unit 3b controls all of the communication terminal apparatus 3 and communicates with the other communication terminal apparatuses. Various types of management information stored in the memory unit 3c are used to control the communication terminal apparatus. Moreover, a communication history is also stored in the memory unit 3c as management information. The control unit 3b also transfers information between the management server 1 over network 2 and the other network apparatus by controlling the network communication unit 3a. For example, various settings are operated by receiving management information transmitted from the management server 1 and the management information stored in the memory unit 3c is read out and transmitted to the management server 1. Since the information is transferred in the structured document format over network 2, the control unit 3b has the function of interpreting this information in the structured document format. Moreover, if the transmitting information is not in the structured document format, it is translated into the structured document format. Likewise, if the data format used in the inner part of the communication terminal apparatus 3 is not in the structured document format, the received information in the structured document format is translated into the inner data format for the inner part. For example, the transmission command and the output command can be received as the information in the structured document format, and if the received information is the transmission and output command, each function can be executed by interpreting.

The memory unit 3c can store various kinds of information. In particular, management information in the communication terminal apparatus is stored. The management information can be stored in the structured document format or in the inner data format accessible in the inner part. If the stored data format is not the structured document format, the management information is translated into the structured document format by the control unit 3b when the management information is transmitted to the management server 1. Likewise, the management information transmitted from the management server 1 is also translated to the inner format by the control unit 3b.

The communication unit 3a, the control unit 3b and the memory unit 3c shown in communication terminal apparatus 3 are also provided in the communication terminal apparatuses 4 and 5. Communication terminal apparatuses 4 and 5 are also capable of receiving and transmitting management information in the structured document format over network 2.

As described above, in the present invention, the management information is received and transmitted at least between the management server 1 and the communication terminal apparatuses 3˜5. Management information includes setting information for various settings for the communication terminal apparatuses 3˜5 and communication history information stored in the communication terminal apparatuses 3˜5. Management information further includes the following information:

Communication history information;

apparatus setting information;

destination information;

delivery setting information;

user information;

apparatus capability information; and,

command information.

The communication history information is a record stored in memory unit 3c of every communication session (transmitting and receiving information) conducted by the communication terminal apparatuses 3˜5. The communication history information includes information about communication results in each communication session. When communication history information is transferred to the management server 1, the management server 1 manages all of the communication sessions in the communication terminal apparatuses 3˜5. Moreover, if the management server 1 transmits information to one of the communication terminal apparatuses, the communication results are used in determining which communication terminal apparatus the information is delivered to for delivery management. Furthermore, the system is designed such that the communication history information is exchanged between the communication terminal apparatuses. For example the communication history information could be delivered or stored in one of the communication terminal apparatuses.

The apparatus setting information provides information for the various settings in each of the communication terminal apparatuses 3˜5. For example, the communication terminal apparatuses 3˜5 can be controlled and managed by the management server 1 by transmitting the apparatus setting information from the management server 1 to the communication terminal apparatuses 3˜5. Moreover, each communication terminal apparatus 3˜5 can perform operations using the settings of the other communication apparatuses by exchanging the apparatus setting information among the communication terminal apparatuses 3˜5.

The destination information includes information regarding where the information is to be sent. Such information includes a telephone number, an e-mail address or a telephone book with an address book including the name of the recipient of the information. For example, the telephone number and the e-mail address when transmitting the information can be extracted from the destination information. Moreover, when receiving the information, additional information regarding the sender can be obtained by referring to this destination information based on the information regarding the sender that is obtained in communicating. This destination information generated and updated in the management server 1 can be transmitted and registered in the communication terminal apparatuses 3˜5. Moreover, the destination information can also be accessible by each of the communication terminal apparatuses 3˜5 by exchanging the destination information among the communication terminal apparatuses 3˜5.

The delivery setting information includes information for setting the delivery address of the received information used in case the communication terminal apparatuses 3˜5 deliver information to other network apparatuses connected to the network 2. All of the delivery addresses can be managed by the delivery address setting information provided in the management server 1. The management server 1 registers and updates the communication terminal apparatuses 3˜5. Moreover, when the delivery setting information is exchanged among the communication terminal apparatuses 3˜5, the information can be delivered even if the information is received by any of the communication terminal apparatuses 3˜5.

The user information, prepared for identifying and managing a client, a group and a department using the communication terminal apparatus, is often used in limiting the use and charge. For example, when the communication history information including the user information is transmitted from each communication terminal apparatus 3˜5 to the management server 1 after delivering the user registered information from the management server 1 to each communication terminal apparatus 3˜5 in charging, the management server 1 can manage to charge intensively.

The apparatus capability information includes communication protocols, communication capabilities, scanning and printing capabilities, data formats, etc. A communication terminal apparatus transmits this information when communicating with the management server 1, other communication terminal apparatuses and other network apparatuses. A communication is established according to the capabilities of the receiving apparatus. For example, the management server 1 can request the capability of each of the communication terminal apparatuses for each transmission or reception in a communication session and categorize these capabilities.

As described above, various types of information set in the communication terminal apparatuses 3˜5 and stored in the communication terminal apparatuses 3˜5 can be exchanged in the standardized structured document format. Conventionally, the information must be received and transmitted in the various protocols and data formats according to the communication apparatus model and information type. Moreover, the communication cannot be established as the data formats and the protocols are sometimes different. However, in the present invention, as the structured document format is used as the standardized data format in exchanging information, communication and management of information can occur.

Further, the command information in requesting various processes such as transmitting and outputting information to the communication terminal apparatuses 3˜5 and extracting the received information can be standardized by using the structured document format. For example, a request can be made using standardized information by using the structured document format even if transmitting or outputting from the management server 1 to the communication terminal apparatuses 3˜5. Moreover, information can be easily exchanged by standardizing the command information even if information is exchanged among the communication terminal apparatuses.

Some formats such as XML etc., can be used as the structured document format of the present invention. In using XML, the data format of the management information transmitted to each communication terminal apparatus 3˜5 can be standardized and the management information received from each communication terminal apparatus 3˜5 can also be handled in a unified manner by transmitting DTD (Document Type Definition) in the receiving and transmitting management information from the management server 1.

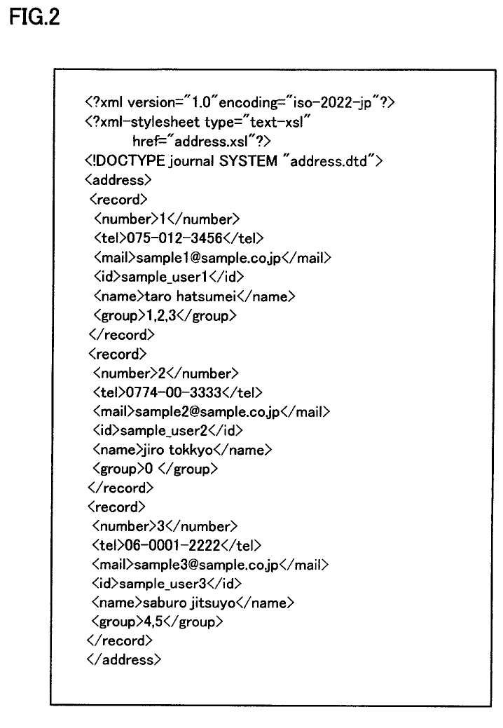

FIG. 2 is an example of management information written in XML. The example of FIG. 2 illustrates a part of the destination information. The part between tags “<record>” and “</record>” is destination information including a telephone number, an e-mail address, an ID, a destination name and a group number along with a serial number. The serial number is located between the tags “<number>” and “</number>”, and likewise, the telephone number is located between tags “<tel>” and “</tel>”, the e-mail address between tags “<mail>” and “</mail>”, the ID between tags “<id>” and “</id>”, the destination name between tags “<name>” and “</name>” and the group number between tags “<group>” and “</group>”. The three destination information including the information is registered in an example illustrated in FIG. 2.

For example, the XML document illustrated in FIG. 2 is generated by the management server 1, and the destination information can be added or updated by transferring it to the communication terminal apparatuses 3˜5. Of course, other management information and command information can be received and transmitted by writing in XML.

Moreover, in using XML, the definition of tag can be freely described. For example, the various kinds of tags used in the example of FIG. 2 can be used commonly by describing the DTD. In the example as illustrated in FIG. 2, the file name of the definition file “address. dtd” is specified in line four and the data format is standardized. When the description of the DTD is delivered from the management server 1 to each communication terminal apparatuses 3˜5 for example, the management information can be described by using the standardized data format (tag) in any of the other apparatuses. Moreover, as the data format can be standardized like this, the information can be transferred to any apparatus and the information can be recognized correctly even in the transferred place. Further, even if various kinds of information is accumulated from each communication terminal apparatus 3˜5 to the management server 1 for example, the same process can be done regardless of the communication terminal apparatus model and the information can be easily managed.

Furthermore, in using XML, the output format information can be standardized. For example, though the file name of the style file “address. xsl” is specified in line three in the example illustrated in FIG. 2, the same information can be outputted in the same format by standardizing this style format even if outputting in any of the communication terminal apparatuses 3˜5. For example, the style file can be transmitted from the management server 1 to each communication terminal apparatus 3˜5. Each communication terminal apparatus 3˜5 layouts each information with reference to the transmitted style file and outputs in outputting the management information written in XML by interpreting.

Conventionally, the output format is determined respectively in each communication terminal apparatus 3˜5 and most of the output formats differ depending on the apparatus model. If the style format is delivered as described above, however, the information can be output from each communication terminal apparatus 3˜5 by the standardized output format regardless of the apparatus model.

Additionally, the structured document format is not limited to XML and various kinds of structured document formats can be used such as Standard Generalized Markup Language (SGML) which becomes the base of XML and Open Document Architecture and interchanging format (ODA). In any event, various kinds of information and command information can be standardized as the structured document and the information can be used by the standardized process. Moreover, the output format can be defined separately and the different output formats for various apparatuses can be reduced.

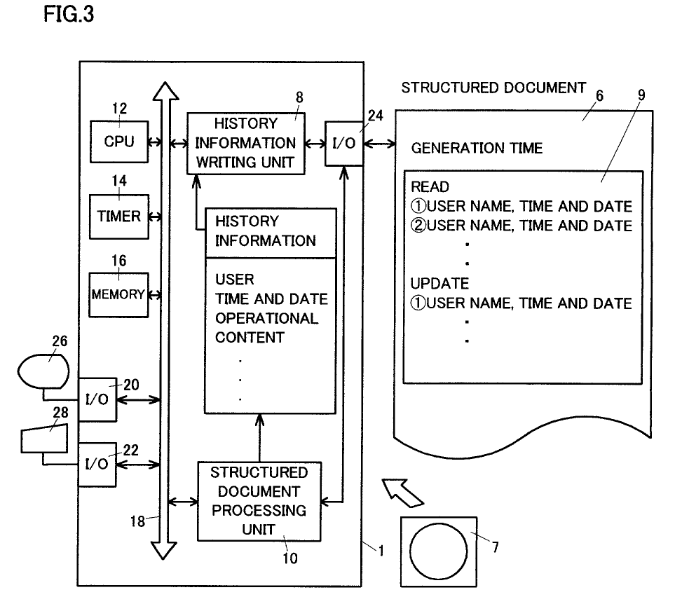

FIG. 3 is a diagram illustrating a structured document management apparatus (management server) in more detail. An image communication apparatus such as a facsimile server and a scanner can be connected to the document management apparatus when an attachment file is created in the image file. The structured document can be managed by reading the program for the structured document management from a proper recording medium 7 such as a DVD or CD-ROM. In the preferred embodiment of the present invention, a structured document 6 is processed and history information of the document is embedded in the attribute information of the structured document 6 in the structured document management apparatus 1. In the structured document management apparatus 1, a structured document processing unit 10 for processing all aspects of the structured documents embeds the process to the structured document generated by lapse of time after generating documents in the structured document 6 as the history information 9 through a history information writing unit 8. A CPU 12, a timer 14 and a memory 16 are connected by a bus 18. Input/output units 20, 22 are connected to a display 26, a keyboard 28 respectively and an input/output unit 24 is provided for processing the structured document 6 and embedding the history information.

The generation time and the history information 9 of the document is embedded in the structured document 6 in FIG. 3, and the history information includes reading and updating the user name and the time and date are embedded respectively. If the content of data in the document is image data, it is linked with the image data file by structuring the data in the SVG format or another format such as XML.

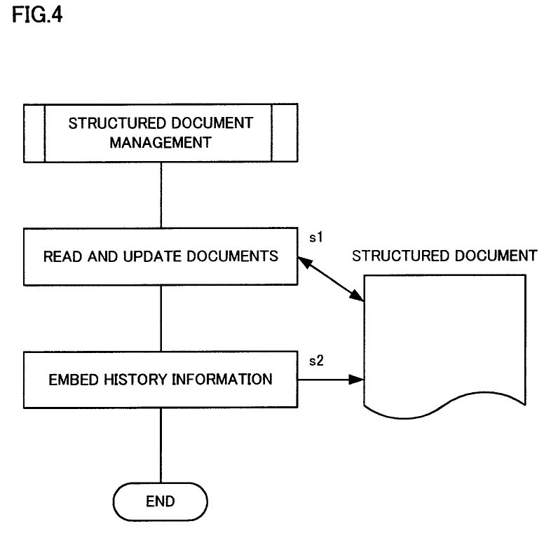

FIG. 4 illustrates an example of an algorithm for a structured document management apparatus according to FIG. 3. In one preferred embodiment of the present invention, the structured document is read and updated in the structured document processing unit 10 and the history information is embedded in the history information writing unit 8. However, the history information can be embedded in the structured document processing unit 10. If a user requests to process the structured document, the structured document processing unit 10 reads and updates the document based on the request (step 1), and the information of a user name, a process content, process time and date and the processed part of the document is transmitted to the history information writing unit 6 as history information. The history information writing unit 8 embeds the received information in the attribute information of the structured document as history information (step 2). Additionally, the structured document processing unit 10 transmits the data necessary to the user.

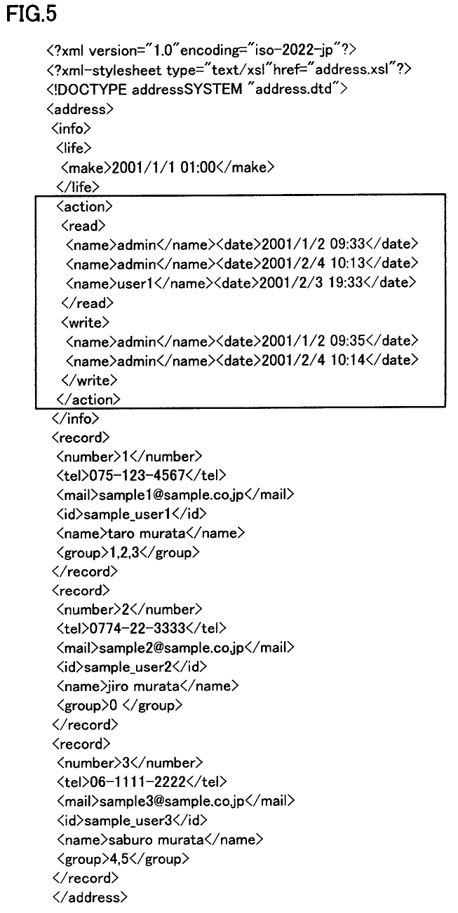

FIG. 5 illustrates an example of translating user address data into a structured document. The generation time of the document is embedded into the document and history information is described as a document attribute by generating a tag. The document is structured after the XML declaration and the document type declaration. In FIG. 3, the name of the user reading the document and the time the document was generated are described first as attribute information. Next, the name of the user updating (writing) the document and the time the document was updated is then described. If the history information is described as the name of the user who reads and updates the document, then the time and the frequency at which the document is read and updated can be immediately determined.

Although the update type and the part of the document updated are not described in FIG. 5, according to one embodiment of the present invention, the part of the document that has been added, changed or eliminated can be simply shown to the user. For example, the strings “<add>number2</add>” and “<history><account>user1</account>add number2</history>” described as an element in the tag <write> of the history information displays the data added to number 2. Likewise, the strings “<alter>number2</alter>” and “<history><account>user1</account>alter number2</history>” displays altered (changed) data for number 2. Furthermore, the strings “<delete>number2</delete>” and “<history><account>admin</account>admin</account>delete number2</history>” displays delete a part (or all) of the data for number 2. Since the element and tag of the history information of the attribute information can be arbitrarily specified, history information is embedded every time the document is accessed based on the structure of a predetermined XML document.

In the simplest history management, only current access information from users can be described in the structured document. Further, the structured document management program can be programmed [such as embedding only the latest history, embedding only the history on the writing and not embedding the reading history.

According to the preferred embodiment of the present invention, history information of an attachment file of the structured document is embedded in the attribute information. The history information includes user names, the operations and the times as well as an updated part of the document and operation content. Documents can be easily managed since a history of the document can be immediately determined by the history information. Moreover, if the process information in accessing structured documents by users is included in the history information of every structured document, the number that users read the documents can be recognized and the frequency and content in renewing the structured document can also be known at a glance. For easy management of the structured documents the document history information can be created with the structured document. It does not need to have the history information stored separately in a database.

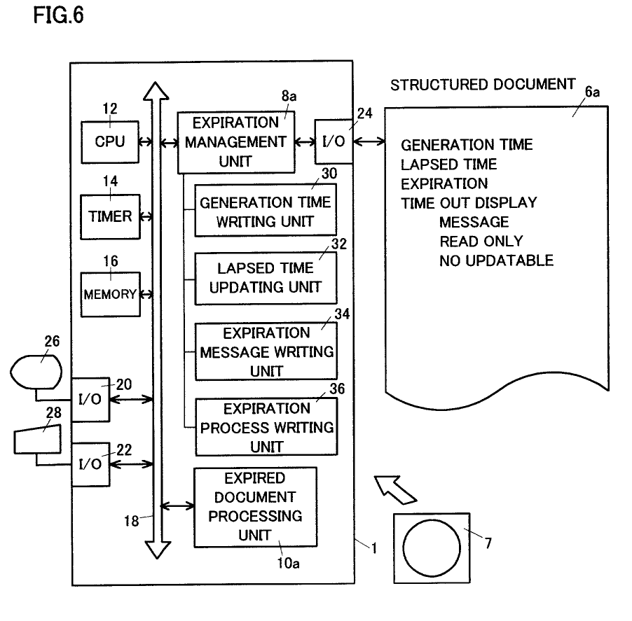

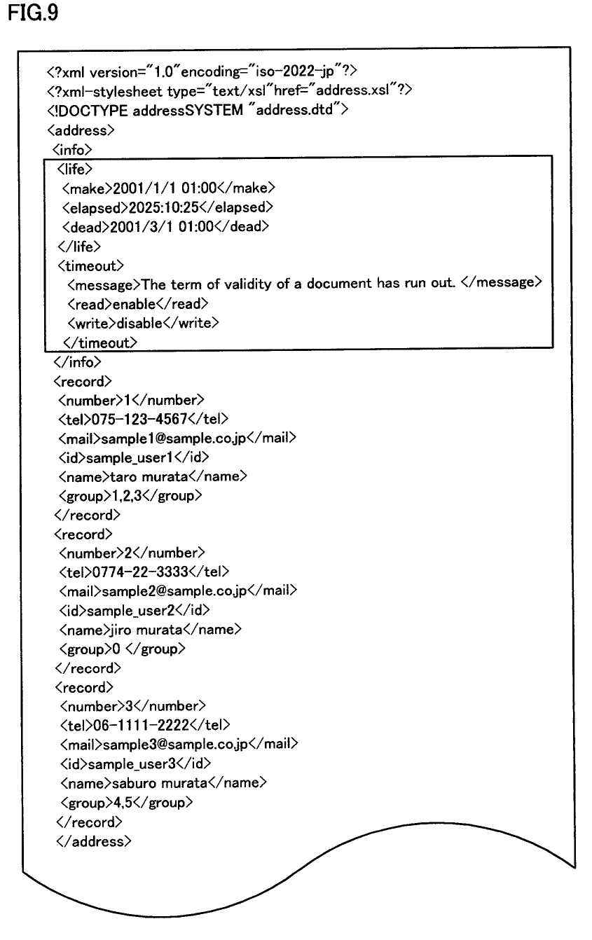

FIG. 6˜FIG. 9 illustrate modifications of the preferred embodiments of the present invention. The management server 1 further includes an expiration management unit 8a and an expired document processing unit 10a for processing the document after expiration of the document. If the data in the document is image data, it is linked with the image data file by structuring the document in the SVG, XML, or other markup language format.

The expiration management unit 8a has a generation time writing unit 30 for embedding the time the document was generated into the structured document 6a, a lapsed time updating unit 32 for embedding the time lapsed between the generation of the document and the current time (the lapsed time from the generation time by updating with the lapsed time), an expiration message writing unit 34 for writing an expiration message indicating the expiration of the message and an expiration process writing unit 36 for defining the process after passing the expiration. After the expiration has been displayed, a “time out display” is written as attribute information in the structured document 6a. Moreover, in the example shown the structured document 6a only allows users to read files and not write to the file after the expiration.

The message for notifying the user of the expiration of the document is written in the expiration message writing unit 34. [When users open the file, the expiration message is displayed. Users can immediately recognize the file has expired by adding the keyword showing the expiration in the file name instead of displaying the message and displaying the keyword in the file list. When the keyword is added, it is possible to display the expiration list by searching keywords.

The process for the expired document in the expired document processing unit 10a includes that the file is deleted automatically after a predetermined time, it can be read but not updated for a certain period for example, the database and the folder saving files are changed and the message for asking users for deleting the file is notified to users etc. The processes for the expired document can be described in the structured document in the expiration processing writing unit 36, and the actual process can be done in the expired document processing unit 10a in the preferred embodiment of the present invention.

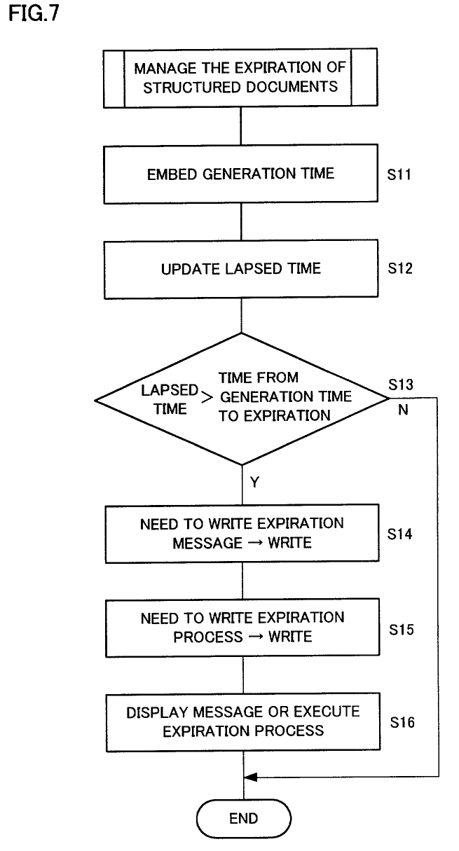

FIG. 7 illustrates the algorithm of the expiration management of the structured document, taking the case of FIG. 6 as an example. The generation time and date is embedded in the attribute information of the structured document as the generation time and date information in generating the structured document (step 11). The lapsed time from the generation time is managed by updating the “lapsed time” that is the element of the attribute information (step 12). When the lapsed time is over a predetermined time or over the expiration specified in advance (step 13), the structured document is made to be the expired document and the reading and updating etc. from users to this document is limited by writing in the expiration process writing unit 36, and if the expiration message is not written in the attribute information, a predetermined message is written in the attribute information (step 14). Likewise, if the expiration process such as the process information that users can read the document but cannot update etc. is not written, the expiration process is written in the attribute information (step 15). In the preferred embodiment of the present invention, the process information relating to the reading and update of the document by the users and the document management such as to delete the document after the expiration is written as the attribute information. In step 16, the expiration message is displayed in the display panel and a predetermined process on the expired document is done.

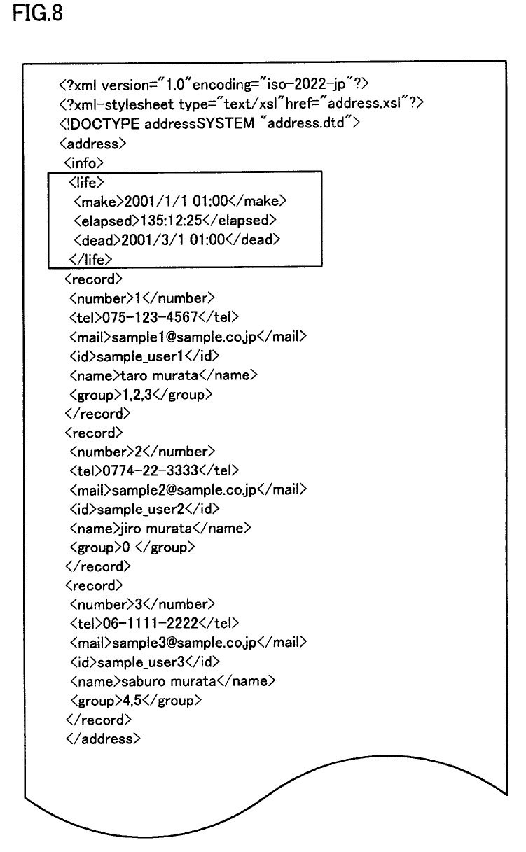

FIG. 8 and FIG. 9 illustrate an example of translating the user address data into structured document. The expiration management information is described in the field of the document attribute by generating tags and structuring. FIG. 9 describes the generation time, the lapsed time and the expiration time as the attribute information. Here, as the document is generated at 1:00 am on Jan. 1, 2001 and the lapsed time is 135 hours 12 minutes 25 seconds, it shows that it does not reach the expiration until 1:00 am on Mar. 1, 2001. As the generation time and the lapsed time of the document are managed by the attribute information, the expiration can be managed correctly by acquiring the lapsed time from the generation time even if the clock time in each of a plurality of terminals connected to the document management apparatus are different. Moreover, the expiration can be managed correctly even if the time setting of the clock in the document management apparatus goes wrong.

In FIG. 9, the expiration has been already passed as 2025 hours 10 minutes 25 seconds is passed from the same generation time and the “time out information” is described. In FIG. 9, the expiration is notified to users by the message “the document is expired” and the description that users can read the data but cannot write. If the delete of the document is instructed to users, “Delete?” can also be described as the expiration message after the message in the message space. The inquiry can also be embedded in the document for example one month after the expiration. If “<delete>timeout+two months</delete>” is described in the document as the attribute information, the document management apparatus can delete the document automatically further two months after the expiration.

Additionally, the attribute information of the entire structured document managed in the document management apparatus 1 can be updated all at once. For example, two months to the delete of the document can be three months etc. here.

According to the preferred embodiment of the present invention, the expiration of the attachment file of the structured document is managed by using attribute information. Attribute information includes the time the document was generated and the lapsed time between the time the document was generated and the time the document expired, so that the elapsed time after the expiration can be recognized immediately and users can manage the document easily. As the message is embedded in the expired document, users can recognize that the document has expired. Furthermore, the limit of the process is informed to users by describing the process information of the expired document such that users cannot update the document by the limitation as the attribute information. Besides, the structured document management apparatus deletes the document and change the database etc. to the expired document.

What is claimed is:

1. A communication apparatus comprising:
a memory means for storing management information in a structured document format;
a network communication means for communicating with at least one of a plurality of network apparatuses through networks; and
a control means for receiving and transmitting the management information in the structured document format between at least one of the plurality of network apparatuses via the network communication means.

2. The communication apparatus as in claim 1, wherein the management information includes at least any one of apparatus setting information defining the operation of the communication apparatus and history information of transmitted and received data.

3. A communication apparatus comprising:
a memory means for storing management information;
a network communication means for communicating with at least one of a plurality of network apparatuses through networks; and
a control means for translating the management information read from the memory means into a structured document format before transmitting the management information to at least one of the plurality of network apparatuses and translating the management information in the structured document format received from at least one of the plurality of the network apparatuses into the management information before storing the management information in the memory means.

4. The communication apparatus as in claim 3, wherein the management information includes at least any one of apparatus setting information defining the operation of the communication apparatus and history information of transmitted and received data.

5. A communication apparatus comprising:
a network communication means for communicating with at least one of a plurality of network apparatuses through networks; and
a control means for processing information based on a command accepted by at least one of the plurality of network apparatuses through the network communication means and which accepts the command described in a structured document format.

6. A structured document management apparatus for managing at least one of a plurality of communication apparatuses comprising:
a network communication means for communicating with at least one of a plurality of network apparatuses through networks; and
a management means for receiving and transmitting management information in a structured document format among at least one of the plurality of communication apparatuses through the network communication means and managing the management information of the network communication means.

7. A management server for managing at least one of a plurality of communication apparatuses comprising:
a network communication means for communicating with at least one of a plurality of a communication apparatuses through networks; and
a management means for managing a process in the network communication means and requesting a process to the network communication means, which requests the process to the network communication means by the command in a structured document format.

8. A structured document management apparatus comprising:
a memory means for storing history information of a structured document; and
an embedded means for embedding history information of the structured document in the structured document as attribute information.

9. The structured document management apparatus as in claim 8, wherein the history information includes information about users that access the structured document.

10. The structured document management apparatus as in claim 8, wherein the history information includes information about access content of the structured document.

11. A method for managing a structured document comprising:
creating a structured document;
updating the structured document; and
embedding history information of the structured document in the structured document as attribute information; and

12. The method as in claim 11, wherein the history information includes information about users that access the structured document.

13. The method as in claim 11, wherein the history information includes information about access content of structured document.

14. A structured document management apparatus comprising:
means for embedding a generation time of a structured document and a lapsed time from the generation time in the structured document as attribute information of the structured document; and,
means for managing an expiration of the structured document based on the generation time and the lapsed time.

15. The structured document management apparatus as in claim 14, further comprising a means for embedding in the structured document, expiration information showing that the lapsed time is over at a predetermined time and the structured document has expired as attribute information.

16. The structured document management apparatus as in claim 15, wherein the expiration information includes a message indicating the structured document has expired.

17. The structured document management apparatus as in claim 15, wherein information of a follow up process to the expired structured document is embedded as the expiration information.

18. A method for managing a structured document comprising:
embedding a generation time of a structured document and a lapsed time from the generation time in the structured document as attribute information of the structured document; and
managing the expiration of the structured document based on the generation time and the lapsed time.

19. The method as in claim 18, further comprising:
embedding in the structured document, expiration information showing that the lapsed time is over at a predetermined time and the structured document has expired as attribute information.

20. The method as in claim 19, wherein the expiration information includes a message indicating the structured document has expired.

21. The method as in claim 19, wherein information of a follow up process to the expired structured document is embedded as expiration information.

22. A communication apparatus comprising:
a memory storing management information in a structured document format;
a network communication unit communicating with at least one of a plurality of network apparatuses through networks; and
a control unit receiving and transmitting the management information in the structured document format between at least one of the plurality of network apparatuses via the network communication unit.

23. A communication apparatus comprising:
a memory unit for storing management information in a structured document format;
a network communication unit for communicating with at least one of a plurality of network apparatuses through networks; and
a control unit for receiving and transmitting the management information in the structured document format between at least one of the plurality of network apparatuses via the network communication unit.

24. The communication apparatus as in claim 23, wherein the management information includes at least any one of apparatus setting information defining the operation of the communication apparatus and history information of transmitted and received data.

25. A structured document management apparatus for managing at least one of a plurality of communication apparatuses comprising:
a network communication unit for communicating with at least one of a plurality of network apparatuses through networks; and
a control unit for processing information based on a command accepted by at least one of the plurality of network apparatus through the network communication unit and which accepts the command described in a structured document format.

26. A management server for managing at least one of a plurality of communication apparatus comprising:
a network communication unit for communicating with at least one of a plurality of a communication apparatus through networks, and
a management unit for managing a process in the network communication unit and requesting a process to the network communication unit, which requests the process to the network communication unit by the command in a structured document format.
